(19) United States
(12) Patent Application Publication
(10) Pub. No.: US 2019/0043147 A1
(43) Pub. Date: Feb. 7, 2019

(54) ASSISTANCE GENERATION FOR USERS OF A SOCIAL NETWORK

(71) Applicant: Facebook, Inc., Menlo Park, CA (US)

(72) Inventors: Daniel Gregory Muriello, Menlo Park, CA (US); Daniel Mark Ben-David, San Francisco, CA (US); Jennifer L. Guadagno, Palo Alto, CA (US); Vanessa Callison-Burch, Palo Alto, CA (US); Swithin Ray Tauro, Redwood City, CA (US)

(21) Appl. No.: 15/667,543

(22) Filed: Aug. 2, 2017

(51) Int. Cl. G06Q 50/26; G06Q 50/00; H04L 29/08

(52) U.S. Cl. CPC G06Q 50/265; H04L 67/22; H04L 67/306; G06Q 50/01

(57) ABSTRACT

Methods, systems, computer-readable media, and apparatuses for determining, by one or more computer devices, metadata of a social network indicating whether a user of a social network requires assistance to mitigate self-injury risk to the user.

### BACKGROUND

Aspects of the disclosure relate to techniques for identifying and providing assistance to users of a social network. Social networks can be platforms that facilitate social interactions between users of the network (e.g., messaging, posting images, participating in groups, etc.). Social networks are increasingly becoming integrated with modern society as a means for users to interact with and keep in touch with other users of the social network. Many users utilize social networks as means to express their emotions and/or intentions.

Certain users of a social network may require assistance to prevent harm from occurring to the users. For example, certain users may be at risk of performing self-injury due to internal or external issues. Internal issues may include personal emotions or thoughts of the user. External issues can include cyber bullying, loss of job, a death in a family, etc. and may influence the emotional state of a user. Indications of troubling behavior by a user, e.g., a disturbing post, may be reported within the social network by other users. Assistance provided in response to such troubling behavior can mitigate self-injury risk to a user or even loss of life. However, providing such assistance solely based on manual reporting by other users and subsequent review of such reporting can be inconsistent, difficult to scale, and/or may not adequately identifier troubling behavior within a social network.

Accordingly, a need exists for improved techniques to provide assistance to users of social networks.

### BRIEF SUMMARY

Techniques of the disclosure can be used to identify a user of a social network that may require assistance to mitigate self-injury risk to the user. Many persons who contemplate performing self-injury may communicate their intentions to, for example, seek assistance or attention from their peers or other individuals. Social networks are becoming increasingly popular platforms for communicating with peers and other individuals, thus social networks are increasingly becoming used to communicate users' intentions of self-injury.

Furthermore, as users of social networks interact with the social network, they may provide a wealth of information that can be analyzed to determine which pieces of information (e.g., features) may be used to identify self-injury risk. Actions to a social network that can be used to trigger determination of whether to mitigate self-injury risk can include posting a content item (e.g., text, a picture, a video, a location, etc.), modifying a biography of the user, modifying group association(s), changing privacy setting(s), adding or removing certain friend(s), providing reactions (e.g., likes) to other users' posts, deleting a social network account, etc. Some non-limiting examples of features can include a content item posted on a social network (such as text, a picture, a video, a location, etc.) that may be in response to a user action on the social network. The features may also include information provided by a user to populate their biography (e.g., location, age, gender, school, work location, movie likes, book likes, etc.), group(s) that a user is associated with, friend(s) that the user is associated with, the content of a modification to the social network, historical information regarding past content items posted by or addressed to a user, a time that a modification has occurred, a day of week that a modification has occurred, a privacy setting, a content item length, a number of times that a word of object has been posted to the social network, a number of times that a content item has been shared or reacted to, etc.

The amount of information available via a social network to determine self-injury risk, the number of permutations of values of the features within the information, and the number of actions to a social network performed by users can be difficult if not impossible for human beings to evaluate and/or police to effectively determine which users may require assistance with regards to mitigate self-injury risk. Techniques of the disclosure can include use of a computer device configured to implement a classifier. The classifier can be used to classify an action to a social network and/or corresponding values of features each corresponding to a user of a social network to determine whether the action and/or or values indicate that the user requires assistance to mitigate self-injury risk to the user. The classifier can receive values of features corresponding to a user and make a determination as to whether the values of the features indicate that the user may require assistance.

The classifier can take advantage of machine learning techniques to determine correlations and/or relationships between values of certain features to determine which values of the features (and/or which features themselves) correlate to a user requiring assistance. Such correlations and/or relationships may otherwise be difficult or impossible to identify. The classifier can be adapted over time to account for adapting social conventions, social conditions, etc. The techniques can also include use of a prioritization or grouping module that can be used to group or classify users and/or actions to identify users and/or actions that may require more immediate attention. For example, some actions may indicate that a user may be in imminent danger self-injury risk. As such, a certain user may be assigned a higher priority and/or severity of response than another user. The techniques may also include use of an action selector that can be used to determine which response to a user action is warranted and/or implement the response. For example, the action selector may contact authorities (e.g., police) when a user is deemed to be in imminent danger so that the authorities can intervene.

Using the techniques of the disclosure, user actions to a social network can be examined and acted upon in real time. A popular social network may receive thousands if not millions of such actions daily. As such, it would be difficult if not impossible for people to manually monitor all such actions, especially in an expeditious manner (it should be understood that providing assistance may be time sensitive in order to mitigate self-injury risk). Furthermore, as will be further discussed herein, self-policing of a social network by users of the social network may be difficult if not impossible. The techniques disclosed herein can be used to identify user(s) of a social network that may require assistance to mitigate self-injury risk and/or provide appropriate assistance to the user(s).

In certain embodiments, techniques can include use of one or more internetworked computer devices, the one or more internetworked computer devices implementing a social network. The one or more internetworked computer devices can be configured to identify a user action relating to a user on the social network. The one or more internetworked computer devices can also be configured to obtain values of one or more predetermined features associated with the user action on the social network or the user on the social network. The one or more internetworked computer devices can further be configured to provide the values of the one or more predetermined features to a classifier implemented on the one or more internetworked computer devices, wherein the classifier is trained using (1) previous values of the one or more predetermined features associated with previous user actions on the social network or users on the social network and (2) known outcomes of prior decisions, based on the previous values, to trigger suicide or self-injury (SSI) risk mitigation activity. The one or more internetworked computer devices can additionally be configured to obtain an output from the classifier, the output based on values of the one or more predetermined features associated with the user action or the user. The one or more internetworked computer devices can also be configured to, based on output from the classifier, in response to the user action, determine to perform one or more responsive actions to mitigate SSI risk to the user.

The user action can be one of a plurality of user actions reported by users of the social network as corresponding to SSI risk. The one or more responsive actions can include prioritizing the user action, among the plurality of user actions, for manual review. The user action may not be reported, by a user of the social network, as relating to SSI risk. The user action can comprise posting a content item, by the user, to the social network. The one or more predetermined features can include text from the content item. The one or more predetermined features can include a feature based on a response to the posting of the content item, the response being by another user of the social network. The other user can corresponds to a user profile that is associated, prior to the user action, via the social network, to a user profile of the user.

The classifier can comprise a first tier of at least one sub-classifier and a second tier of at least one sub-classifier. The second tier of at least one sub-classifier can take, as inputs, outputs from the first tier of at least one sub-classifier. At least one of the first tier of at least one sub-classifier can be a text-based sub-classifier configured to receive textual input. At least one of the text-based sub-classifiers can be configured to receive, as input, an n-gram of text as part of the one or more predetermined features. Each sub-classifier of the first tier of at least one sub-classifier can be configured to output a numeric value relevant to the determination to perform one or more responsive actions to mitigate SSI risk to the user.

The at least one sub-classifier configured to output a numeric value can be further configured to receive, as input, a value indicative of a time of day that the user action occurred. The one or more predetermined features can include a group within the social network of which the user is a member, one or more associations of the user within the social network, or biographical information entered to the social network by the user. The one or more actions to mitigate SSI risk to the user can include: (1) generation of a message addressed to a friend of the user (which may include suggested material/messages for the friend to provide to the user to mitigate SSI risk to the user), the message indicating that the user may require assistance; (2) generation of a message to the user including assistive information for mitigating SSI risk to the user; (3) generation of a message addressed to the user including contact information for a third party to mitigate SSI risk to the user; or (4) generation of a message addressed to authorities to intervene in response to determining that the user requires assistance. The one or more predetermined features associated with the user on the social network can include features contained within a profile on the social network, the profile corresponding to the user.

The known outcomes of prior decisions, based on the previous user actions, to trigger suicide or self-injury (SSI) risk mitigation activity can be determined based on manual selection of the outcomes based on the previous values of the one or more predetermined features associated with the previous user actions on the social network. The classifier can be periodically updated with (1) values of the one or more predetermined features associated with previous user actions on the social network and (2) known outcomes of prior decisions, based on the previous user actions, to trigger suicide or self-injury (SSI) risk mitigation activity. A determination by the by the one or more internetworked computer devices to perform the one or more responsive actions can be manually verified.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of a social network infrastructure that may include features of the disclosure;

FIG. 2 illustrates a simplified diagram of a social network that may be implemented with the social network infrastructure of FIG. 1;

FIG. 3 illustrates a simplified diagram of a social network including a classifier that may include features of the disclosure;

FIG. 4 illustrates a classifier that may include features of the disclosure;

FIG. 5 illustrates an example flowchart to implement features of the disclosure regarding training of a classifier;

FIG. 6 illustrates an example flowchart to implement features of the disclosure regarding implementing a classifier;

FIG. 7 illustrates an example of a computing system in which one or more embodiments may be implemented; and

FIG. 8 illustrates an example environment in which one or more embodiments may be implemented;

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

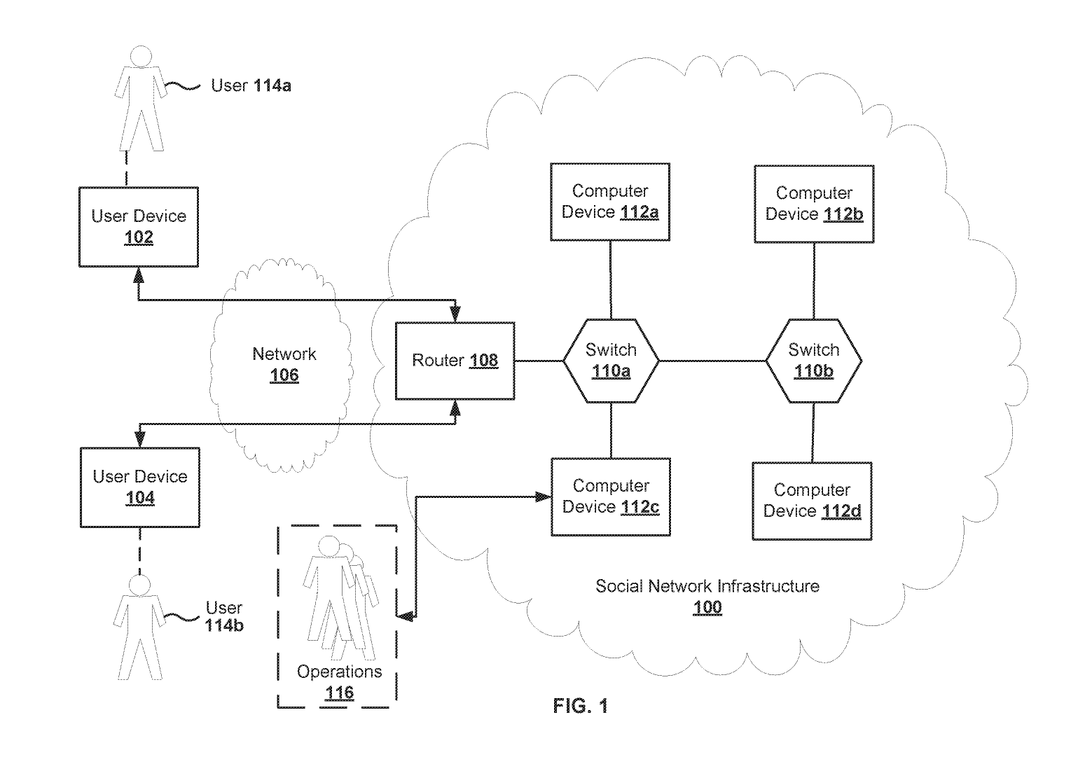

FIG. 1 illustrates a simplified diagram of a social network infrastructure 100 and users 114a-114b that may interact with functionality provided by computer device(s) 112a-112d within the social network infrastructure 100. User 114a may be associated with a corresponding user device 102. User device 102 can be, for example, a computer, a smartphone, a tablet, a smart watch, etc. Similarly, user 114b can be associated with a corresponding user device 104. Each of user devices 102 and 104 can communicate with device(s) of social network infrastructure 100 via network 106. Network 106 can represent, for example, the internet. Network 106 can include various switches or similar devices to facilitate movement of data between user devices 102 and 104 and social network infrastructure 100.

Social network infrastructure 100 can include an edge router 108 that can be used as a gatekeeper (domain separator) between social network infrastructure 100 and external computer device(s) or computer network(s). Although only one router 108 is illustrated, it should be understood that social network infrastructure 100 can include a plurality of routers. Furthermore, social network infrastructure 100 can be distributed across various geographical locations or domain(s) within a computer network (such as the internet). Social network infrastructure 100 can also include a plurality of computer devices 112a-112d that can each be a computer server, access terminal, etc. Switches 110a-110b can be used to forward network packet to or from router 108 and one or more of computer devices 112a-112d to facilitate functionality of a social network.

User 114a may interact, via user device 102, with social network infrastructure 100 to facilitate performing an action to a corresponding social network (such as posting a content item to the social network, providing profile information to the social network, etc.). User 114b may also interact with user 114a via the social network. For example, user 114b may reply, via user device 104 to a content item posted by user 114a. Thus, users 114a-b may perform actions to a social network implemented by social network infrastructure 100 by interacting with respective user devices 102 and 104 coupled to social network infrastructure 100.

Also illustrated are operations personnel 116. Operations personnel 116 can similarly interact with a social network via social network infrastructure 100. Operations personnel 116 may have different privileged access to social network infrastructure 100 as compared to users 114a-114b. Operations personnel 116 may interact with social network infrastructure 100 via a computer device (not shown) coupled to router 108 or directly via a computer device of social network infrastructure 100 (such as computer device 112c). Operations personnel 116 can perform a number of administrative functions, such as reviewing and/or acting on reports submitted by users of a social network implemented by social network infrastructure 100. The reports can be of social network issues (e.g., bugs), outages, inappropriate modifications (e.g., pornographic or illegal data), policy violations, etc.

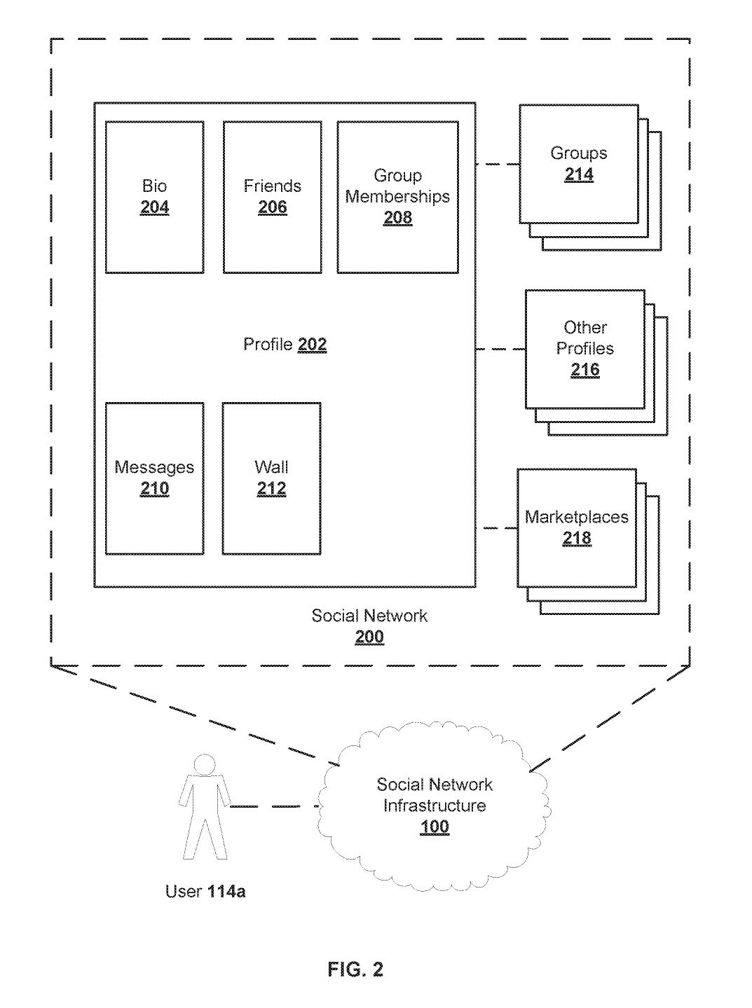

FIG. 2 illustrates a simplified diagram of a social network 200 that can be implemented by social network infrastructure 100. Social network 200 can include, among other things, a plurality of user profiles each corresponding to a user of social network 200. Profile 202 can correspond to user 114a, for example. Other profiles 216 are illustrated that can each correspond to a respective other user of social network 200. User 114a can interact with social network 200 in a variety of manners including performing actions on social network 200.

Action on social network 200 can include changing an aspect of a profile, messaging another users, changing user setting(s), changing a profile's associations within social network 200, any combination of the preceding, or other. For example, user 114a may perform an action on social network 200 by updating their profile 202. An action may include updating biographical information 204 contained within the profile 202, such as updating a profile picture, changing favorite quotes, changing movie or music preferences, changing “likes,” etc. An action may also include changing friend relationships 206 between profile 202 and other profiles 206, for example. User 114a may be associated with other profiles 216 through friendship or other associations/links present within social network 200. The associations can include voluntary sharing of information between the profiles, access to certain information of a profile, etc. Similarly, group membership associations/links 208 can be modified via an action performed by user 114a. For example, user 114a may modify which groups 214 they are a part of Groups 214 may be logically associated profiles of users that share common interests or communicate with each other via a group.

An action may also include posting a content item via a message 210 or wall 212, for example. Message 210 can be a direct, point-to-point communication between user 114a and another user of social network 200. Wall 212 can be a shared posting area wherein multiple users of social network 200 are privileged to read and/or modify (via posting of a content item, for example) the posting area. An action to social network 200 may include an action directed to another user's profile such as a profile of other profiles 216. User 114a may, for example, post a content item to a group 214, a wall of another user's profile 216, and/or to a marketplace 218. Marketplaces 218 may be areas within social network 200 wherein users may post items or services for sale or communicate a desire to purchase an item or service.

Certain users of social network 200 may not have an associated profile. For example, certain users may access a profile of a user of social network 200 without themselves having a profile. They may access a content item posted by another user on a wall, within a group, within a marketplace, etc. Such a user may be considered a guest user and may have limited privileges within social network 200. Furthermore, data associated with a guest user may be relatively limited as compared to a user having an associated profile within social network 200.

Data can be created within social network 200 in response to actions by users within social network 200. Certain features can be identified within the data that may be used to predict whether a user may be at risk of self-injury. For example, user 114a may perform an action of posting a content item to one of groups 214. Other users (not shown) may respond/comment to the content item by posting their own content item(s). These other users' content items may become features that may be used to predict if a user is at risk of self-injury. Some other examples of features may be names of groups 208 that a user is a member of, biographical information 204 posted by a user, historic information of previous posting of content item(s) by a user, posting of content item(s) to a user's own wall or messaged to a user, etc.

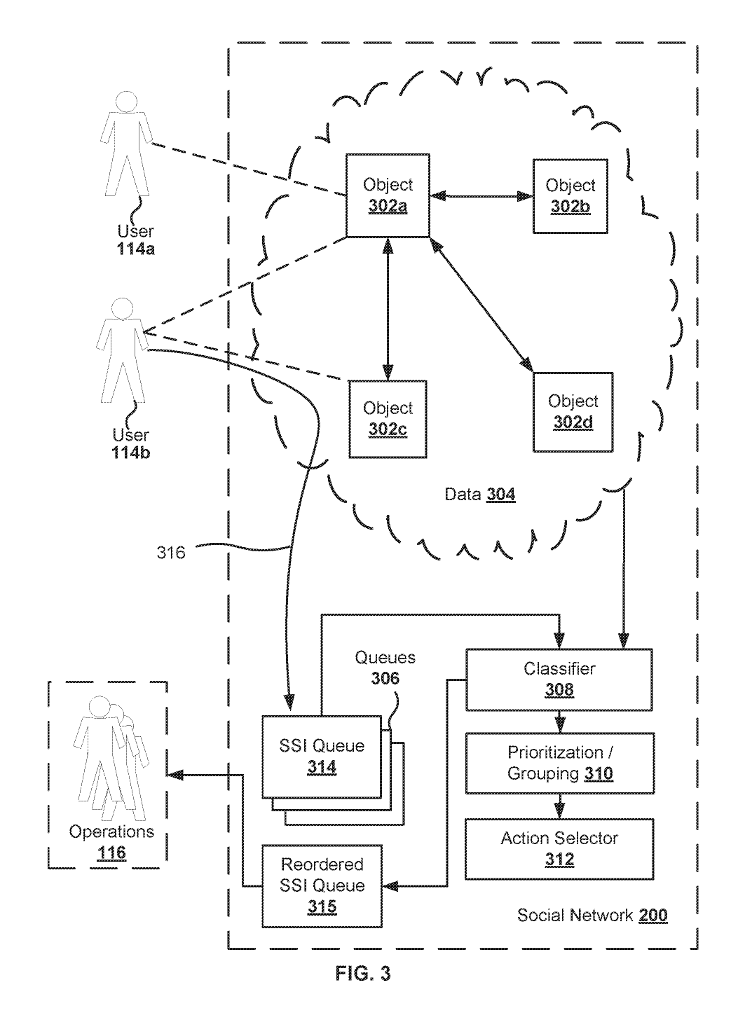

FIG. 3 illustrates social network 200 and objects 302a-302d which each may be modified via action(s) performed user 114a or user 114b. Objects 302a-302d can represent groups, walls, messages, marketplaces, etc., such as those illustrated in FIG. 2. As one example, user 114a may post a content item to object 302a and user 114b may post a responding content item to object 302a. Furthermore, User 114a may post to object 302b and another user (not illustrated) may post a response in object 302b. User 114b may also post a content item to object 302c regarding user 114a which may form part of data 304. As users interact with objects 302a-302d, they may generate data 304 within social network 200. The data 304 can form a pattern or fingerprint which may be used to infer whether a set of behaviors associated with the user(s) is indicative of a likelihood of suicide and self-injury. For example, certain inferences regarding user 114a may be determined as user 114a interactions with (e.g., modifies) social network 200 and other users (such as user 114b) respond to the interactions. These interactions can collectively form data 304. Data 304 may also include metadata (e.g., background data within social network 200 that may be associated to a user or user action but may not be directly assessable by a user).

Determining a user's intention regarding self-injury risk may take advantage of data and/or metadata related to a user and/or other users associated with the user. As one example, a first user may repeatedly post content items which, in other contexts, may indicate an intent to perform self-injury, but the first user may have no intention of performing self-injury (e.g., they may be posting content items sarcastically). A second user may only post the same content items when they intend to perform self-injury. However, using content items posted by groups of users (e.g., a user under examination and responses to a post by the user under examination), a relatively high accuracy inference can be determined by collectively examining the postings by the various users regarding a user's intent to perform self-injury.

Operations personnel 116 may responds to service requests (such as service request 316 provided by user 114b). Service requests may be organized into queues 306. Each of queues 306 can be associated with a type of service request (such as server maintenance, content items being posted with inappropriate material, etc.). Each of queues 306 may be organized based on priority. One of queues 306 (e.g., SSI Queue 314) may be associated with users that may require assistance to mitigate self-injury risk. Queue 314 may be given relatively higher priority over others of queues 306. For example, queue 314 may have a lower target response time than lower priority queues. Applicant has found that, in such a queue configuration, users of social network 200 may determine which of queues 306 are assigned higher priorities and utilize higher prioritize queues to address other, lower-priority, concerns. For example, users may inaccurately (and purposefully) report inappropriate/pornographic postings as indicating that a user requires assistance regarding self-injury. The higher priority queue(s) then become inundated with service requests that do not belong in the higher priority queue, hindering operations personnel's 116 ability to address high priority service requests. Techniques disclosed herein can be used to prioritize actions reported to an SSI queue 314, so that actions likely to be related to SSI risk are given higher priority and thus more likely to be expeditiously reviewed by operations personnel 116. Actions determined by the present techniques to be less likely to be related to SSI risk can be given lower priority for review by operations personnel 116.

Classifier 308 is illustrated as a module of social network 200. Classifier 308 can be implemented by one or more of computer devices 112a-112d and can be configured to identify actions that indicate that user(s) that may require assistance to mitigate self-injury risk to a user. As illustrated, data 304 may be provided to classifier 308. Classifier 308 can be trained to identify certain combinations or patterns of values of features within data 304 that indicate that a user (such as user 114a) may require assistance to mitigate self-injury risk to the user. In certain embodiments, classifier 308 can output a binary classification of an action, the classification indicating that the action indicates that a user may require assistance to mitigate self-injury risk and a corresponding confidence level regarding the classification. In certain embodiments, classifier 308 may output multiclass classification(s) regarding a user action to mitigate self-injury risk to a user (e.g., a classification of level of severity, a suggested response to mitigate the risk, etc.). Classifier 308 may be one of several classifiers used to determine and/or evaluate SSI risk and/or part of a more fully features classifier that may be used to populate a plurality of queues (e.g., queues regarding inappropriate content, bullying behavior, a fault in social network 200, SSI risk, etc.). Classifier 308 may also output one or more values indicative of a level of severity of SSI risk that an action indicates, a level of immediacy of action required to mitigate SSI risk, etc.

Classifier 308 can, in certain embodiments, be used to reorder elements within SSI Queue 314 in order to determine which elements may be more likely to accurately indicate a user that may require assistance to mitigate self-injury risk and which elements may be erroneously within SSI queue 314 (e.g., through voluntary miscategorization by user 114b or a mistake by user 114). Classifier 308 can then output the elements into reordered SSI Queue 315. Reordered SSI queue 315 can include elements of SSI queue 314, but in a different order. Classifier 308 may also remove elements of SSI queue 314 when populating reordered SSQ queue 315. In certain embodiments, social network 200 may include on SSI queue that is ordered based on output from classifier 308. For example, as service requests (such as request 316) allegedly pertaining to SSI or reported by users of social network 200, then may be evaluated and/or inserted into an SSI queue for later manual review (or autonomous or semi-autonomous review/response). Applicant has found that reordering elements within a SSI queue using classifier 308 can double a number of users being provided assistance for self-injury based concerns. Furthermore, Applicant has found that use of classifier 308 can identify, based on values of features, users that may require assistance with six times more accuracy as compared to a human operator.

In certain embodiments, classifier 308 can be used to autonomously or semi-autonomously formulate and implement a response to a user action to mitigate self-injury risk to the user. For example, classifier 308 can evaluate request 316 and/or actions by users 114a or 114b on social network 200. Classifier 308 may be configured to analyze and/or implement actions for a large number of actions to a social network that may be impossible or inefficient for manual evaluation by operations personnel 116. Furthermore, types of actions that may be determined to indicate self-injury risk to a user may be analyzed by classifier 308 that may be inaccessible by operations personnel 116. For example, an action of deleting an account or personnel messages of a user may be inaccessible by operations personnel 116 without a service request from a user (such as service request 316).

Prioritization/grouping module 310 can prioritize or group actions that may indicate that corresponding user(s) require immediate assistance or a higher priority response. Prioritization/grouping module 310 may work in conjunction with action selector 312. Prioritization/grouping module 310 may categorize and/or group actions in one or more queues (not shown) for action selector. Prioritization/grouping module 310 may determine, based on corresponding output from classifier 308, which of actions may require immediate assistance

Action selector 312 can select and/or implement an appropriate action in order to provide assistance to a user. For example, action selector 312 may implement a relatively high priority response (e.g., contacting local authorities) if a user has been determined to be in imminent risk of self-injury requiring immediate assistance. Further actions can include contacting one of operations personnel 116 to intervene, providing a user with contact information regarding groups or associations that provide help regarding self-injury, and/or providing a user with materials to aid in avoiding self-injury or related issues.

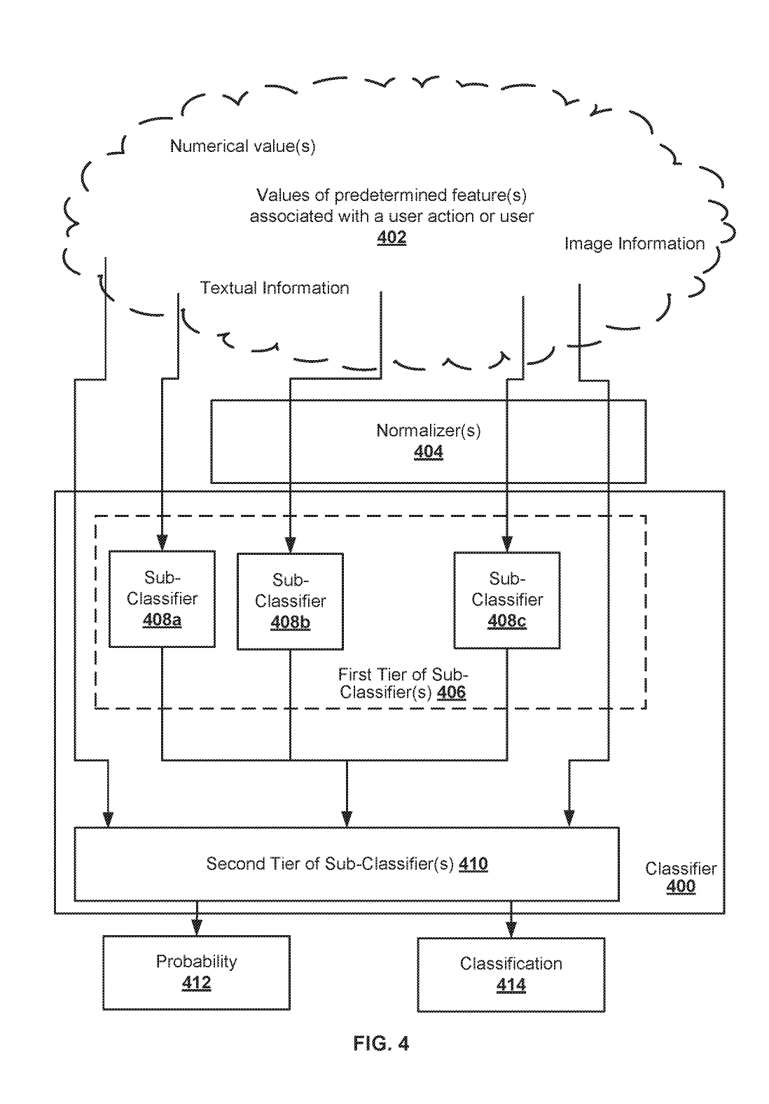

FIG. 4 illustrates a logical view of classifier 400 that can be similar to classifier 308. Classifier 400 can receive values of predetermined feature(s) associated with a user action or user 402. Values of predetermined feature(s) associated with a user action or user 402 can be included within data 304, for example. Values 402 can be values of features that can be formatted as images, text, numbers, etc. Normalizer 404 may be used to: (1) commonize a format of values of features, (2) normalize the values of the features to a common scale, and/or (3) normalize the results of the commonization to a common scale. Commonization can include transforming each of the values of the features into a common data type or representation of the value. Normalization can include multiplying each of the values with a respective scaling factor to bring them to the common scale.

Classifier 400 can, in certain embodiments, include a first tier of sub-classifier 406 and a second tier of sub-classifier(s) 410. Sub-classifiers 408a, 408b, and 408c are indicated as being included within first tier of sub-classifier(s) 406. Each of sub-classifiers 408a, 408b, and 408c can correspond to a respective predetermined feature for evaluation of value(s) contained therein. For example, sub-classifiers 408a, 408b, and 408c can implement symbol detection and evaluation techniques to determine an output numerical representative value of a textual input of a values of a predetermined feature corresponding to a user action. In certain embodiments, first tier of sub-classifier(s) 406 may output a value compatible with second tier of sub-classifier(s) 410. For example, certain ones of first tier of sub-classifier(s) 406 may take as input textual information and output numerical value(s) indicating a likelihood that the input textual information indicates that a user may require assistance to mitigate self-injury risk.

Symbol detection can be used to determine symbol(s) (e.g., n-grams or tokens) that are correlated to data that may be indicative of a user requiring assistance to mitigate self-injury risk. For example, classifier sub-classifier 408a, 408b, or 408c may be unable to understand human language (e.g., sub-classifier 408a, 408b, or 408c may be unable to understand that the word “dog” refers to a mammal with four legs and a tail). Similarly, sub-classifier 408a, 408b, or 408c may be unable to understand that a specific word may be associated with self-injury risk. However, sub-classifier 408a, 408b, or 408c may be able to identify certain patterns of symbols that have been found in the past to be indicative of self-injury risk and may be a good predictor of future indications of self-injury risk. As one example, sub-classifier 408a, 408b, or 408c may partition a value of a feature into several different sized portions. For example, a feature may include textual value and the text may be broken in different sized portions (e.g., portions of size 1 letter, 2 letters, 1 word, 2 words, 1 sentence, etc.). Each of the portions can be used to determine whether a value of the portion (or in any combination of portions) is likely to indicate that a user may require assistance. Similarly, images may be decomposed into different sized portions (e.g., each portion can have different numbers of pixels). Linear regression may be used to assign a numerical value to each value of a feature based on symbols contained in the value and a reference value corresponding to each of the symbols. The reference values corresponding to the symbols can be numerical representations indicating whether the corresponding symbol indicates that a user is at risk of self-injury.

Symbol detection can have several advantages. For example, symbol detection may remove human bias from determination if a user requires assistance. Symbol detection may also identify certain patterns in features that otherwise may be unnoticeable by a user. Furthermore, symbol detection provides a great deal of flexibility when processing features of different data types (e.g, text, images, numerical values, etc.).

Second tier of sub-classifier(s) 410 can be used to implement certain models that may have been trained or otherwise configured to predict whether certain value(s) of predetermined features 402 (and/or outputs of first tier of sub-classifier(s) 406) indicate that a user may require assistance to mitigate risk of self-injury. As one example, a random forest model can be used for prediction. A random forest model can be an ensemble learning model used for classification of values of features that operates by constructing a multitude of decision trees at training time and outputting, at run-time, a class that is the mode of the classes output by individual trees. A class can be a prediction that a user requires assistance, a classification/prioritization of a prediction, etc. A decision tree can be a decision support tool that uses a tree-like graph or model of decisions and their possible consequences, including chance event outcomes, resource costs, and utility.

Another example model that can be implemented via second tier of sub-classifier(s) 410 can be a neural network. A neural network can include a plurality of nodes, each node including a plurality of weighted connections with other nodes. The nodes can be arranged into layers (forming a network). The neural network can include a beginning layer of nodes that can take as input, for example, ones of values 402. The neural network can include an exit layer that can output, for example, an indication that the metadata 402 indicates that a user requires assistance and/or a classification of assistance or user. Several intermediate layers may be logically connected between the beginning layer and the exit layer. The weights of each node can be generated via training such that, at run time, the weights have been assigned and the neural network predicts an outcome in accordance with the training data set. Other forms of machine learning may also be utilized.

As illustrated, classifier 400 may output a probability 412 and/or a classification 414. The classification 414 can be a binary value indicating whether a certain set of values 402 indicates that a user is at risk of self-injury. Classification 414 may also be use a multi-class classification of a type of risk of self-injury, a severity of risk of self-injury, a type of response to mitigate self-injury risk, etc. Probability 412 can include a value indicating a probability that set of values 402 indicates that a user may require self-risk injury mitigation, a confidence level that a value of classification 414 is correct, a severity level corresponding to classification 414, and/or a value indicating an immediacy that a user may require assistance. Classification 414 and/or probability 412 can be used to populate reordered SSI queue 315 when used for manual review of actions. Classification 414 and/or probability 412 can be used by prioritization/grouping module 310 and/or action selector 312 when autonomously or semi-autonomously responding to actions.

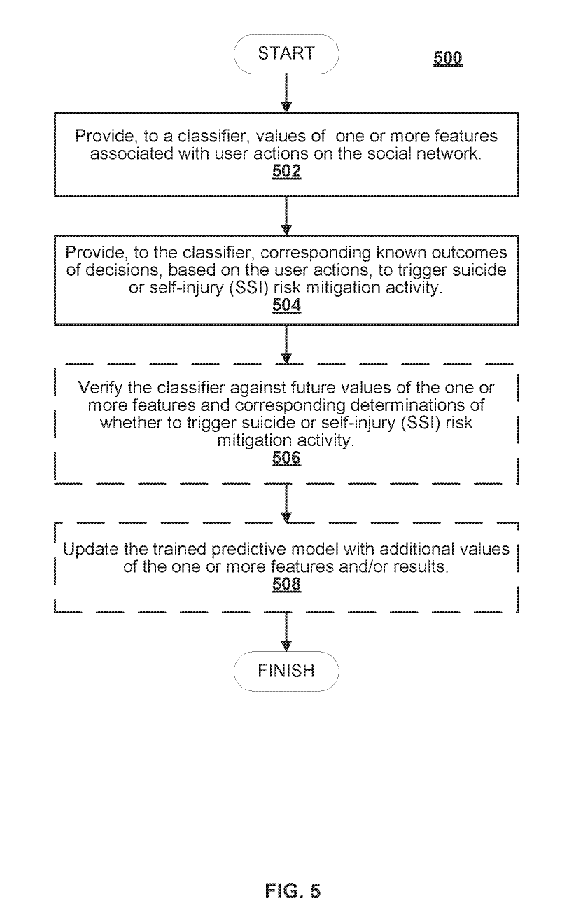

FIG. 5 illustrates a flowchart 500 that can be used to, for example, train a classifier according to certain embodiments to determine that a user may require assistance to mitigate self-injury risk. At 502, values of one or more predetermined features can be provided to the classifier and, at 504, corresponding determinations of whether the values of the one or more features indicate that a user requires assistance can be provided to the classifier. The classifier can use this information to, for example, modify decision points or weights contained therein such that, when provided with similar values of the one or more features, a similar decision is reached. As one example, values of features of data associated with social network user-reported cases of other users that may require assistance can be provided, as illustrated in FIG. 3. A corresponding evaluation by operations personnel of whether the user requires assistance can be used at 504 and provided to train the classifier. 502 and 504 can also be used to determine which of the one or more features are relevant to determine whether a user requires assistance to mitigate self-injury risk. For example, a correlation value can be assigned to each feature and features that are found to be uncorrelated with determination of self-injury risk may not be evaluated by the classifier in the future after the classifier is trained.

After the classifier has been trained, the classifier can then be used to predict, based on future values of features of features, whether the values indicates that a user may require assistance to mitigate self-risk injury. At 506, the trained classifier can optionally be verified against future values of one or more features and corresponding determinations of whether a user requires assistance. For example, operational personnel may, from time to time, provide additional matching features values and determinations. In this manner the classifier can be verified from time to time to assess whether the classifier should be updated to account for, for example, changes in social trends, changes in vernacular, changes in group names associated with self-injury, etc. At 508, the classifier can be updated based on the values provided at 506. For example, weights and/or decision points of the classifier may be altered. Using optional steps 506 and 508, the classifier can become an evolving classifier that retains greater self-injury mitigation accuracy over time. Additionally, features may be added to or removed from the classifier from time to time and the classifier retrained/modified accordingly.

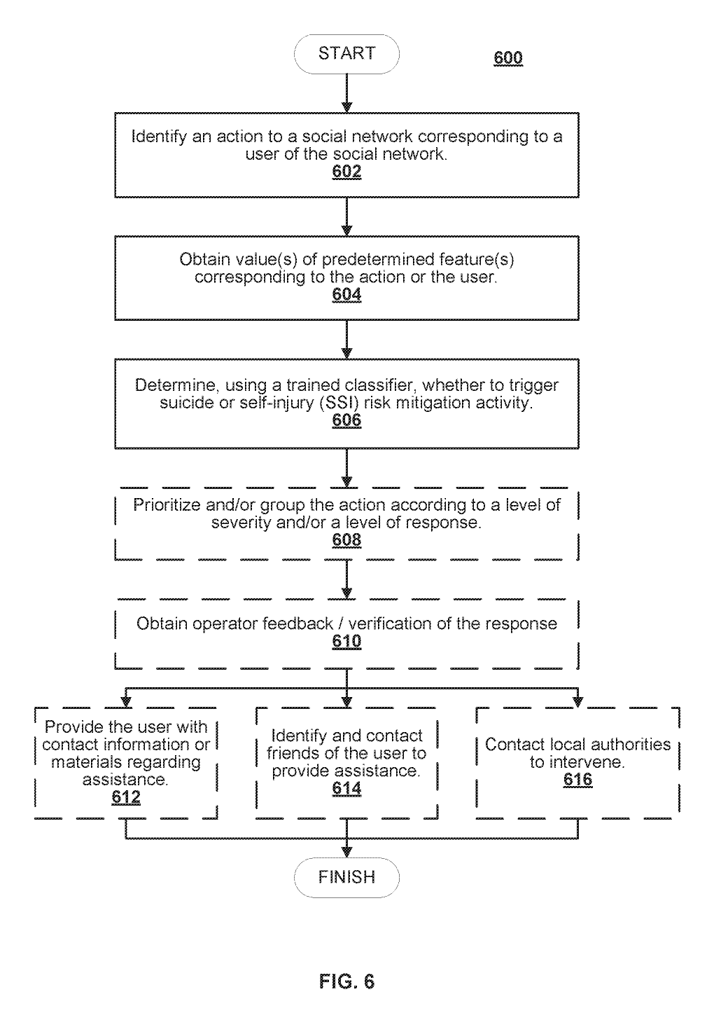

FIG. 6 illustrates a flowchart 600 for implementing a trained classifier. At 602, an action to a social network and corresponding to a user of the social network can be identified. The action can include posting of a content item, joining of group(s), addition or subtraction of friends, etc. The action may be performed by another user of the social network, such as another user posting to a profile of the user of 602. At 604, values of predetermined feature(s) correspond to the action can be obtained. The features can be determined using the process of flowchart 500. The features can include content item(s) posted in response to the user's content item, for example.

At 606, using a trained classifier (such as one created using the process of flowchart 500), a determination can be made as to whether the user requires assistance to mitigate self-risk injury. The determination can be made using classifier 400, for example and, more specifically, based on probability 412 and/or classification 414. At 608, a level of severity and/or a level of response can optionally be determined corresponding to the user by grouping and/or prioritizing actions. The actions can be grouped or prioritized based on probability 412. For example, a high priority/immediate response can be determined for an action indicating that the user corresponding to the action is in immediate danger of self-injury. At 610, operator verification can optionally be obtained. For example, operations personnel may be contacted to confirm, for example, contacting of local authorities to intervene. The operations personnel may also provide feedback to, for example, update the predictive mode.

At 612, 614, and 616 one or more responses can be selected for the user based on the action. For example, at 612, the user may be provided with contact information or material regarding assistance. The contact information can be contact information for an association or help line specializing in aid to users who are at self-injury risk. At 614, friends(s) of the user may be contacted and requested to provide aid to the user in the form of emotional support or other. The friend(s) may be provided with materials and/or suggestions for rendering the aid. For example, the friend(s) may be provided with template message(s) to the user to aid in mitigation of SSI risk. The friend(s) may be located via links on the social network, such as friends 206. At 616, authorities local to the user may be contacted for the authorities to intervene. Local authorities may be contacted in extreme situations wherein a user is deemed to be in imminent danger. Any one of actions 612, 614, or 616 may be conducted by a classifier disclosed herein and/or by operations personnel. In certain embodiments, the classifier may require verification from operations personnel to proceed with certain action(s). Selection between actions 612, 614, and/or 616 may be a results of grouping(s) or prioritization(s) determined at 608.

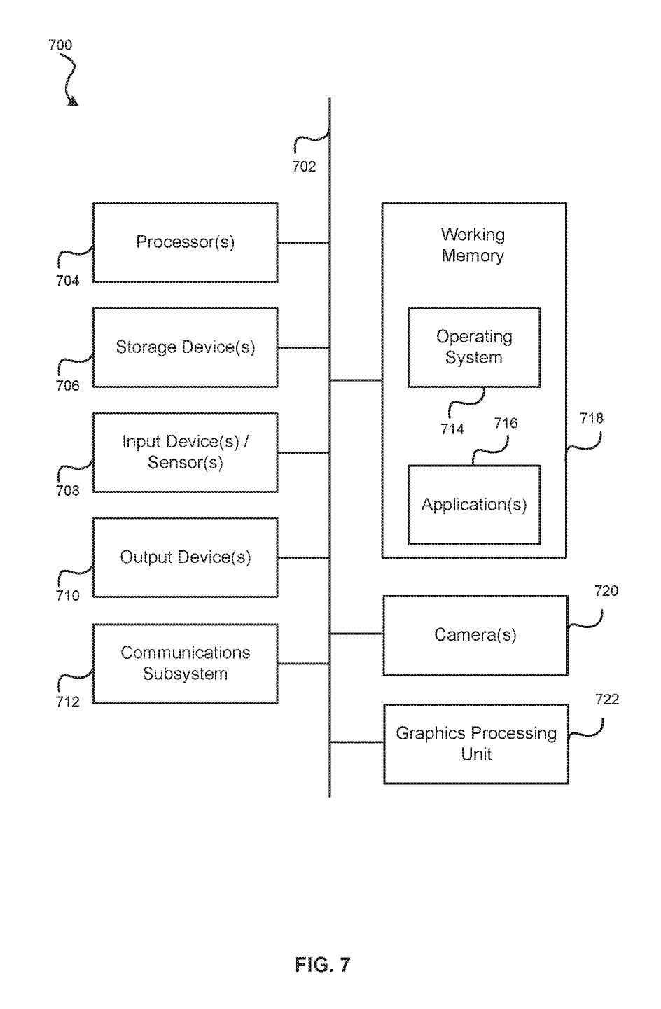

FIG. 7 illustrates an example of a computing system in which one or more embodiments may be implemented. A computer system as illustrated in FIG. 7 may be incorporated as part of the above described computerized device. For example, computer system 700 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 7 provides a schematic illustration of one embodiment of a computer system 700 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner. In some embodiments, elements computer system 700 may be used to implement functionality of any of computer devices 112a-112d of FIG. 1.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special-purpose processors (such as digital signal processing chips, graphics acceleration processors, and/or the like); one or more input devices 708, which can include without limitation one or more cameras, sensors, a mouse, a keyboard, a microphone configured to detect ultrasound or other sounds, and/or the like; and one or more output devices 710, which can include without limitation a display unit such as the device used in embodiments of the invention, a printer and/or the like.

In some implementations of the embodiments of the invention, various input devices 708 and output devices 710 may be embedded into interfaces such as display devices, tables, floors, walls, and window screens. Furthermore, input devices 708 and output devices 710 coupled to the processors may form multi-dimensional tracking systems.

The computer system 700 may further include (and/or be in communication with) one or more non-transitory storage devices 706, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 712 may permit data to be exchanged with a network, other computer systems, and/or any other devices described herein. In many embodiments, the computer system 700 will further comprise a non-transitory working memory 718, which can include a RAM or ROM device, as described above.

The computer system 700 also can comprise software elements, shown as being currently located within the working memory 718, including an operating system 714, device drivers, executable libraries, and/or other code, such as one or more application programs 716, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 700 may be omitted or may be implemented separate from the illustrated system. For example, the processor 704 and/or other elements may be implemented separate from the input device 708. In one embodiment, the processor is configured to receive images from one or more cameras that are separately implemented. In some embodiments, elements in addition to those illustrated in FIG. 7 may be included in the computer system 700.

Some embodiments may employ a computer system (such as the computer system 700) to perform methods in accordance with the disclosure. For example, some or all of the procedures of the described methods may be performed by the computer system 700 in response to processor 704 executing one or more sequences of one or more instructions (which might be incorporated into the operating system 714 and/or other code, such as an application program 716) contained in the working memory 718. Such instructions may be read into the working memory 718 from another computer-readable medium, such as one or more of the storage device(s) 706. Merely by way of example, execution of the sequences of instructions contained in the working memory 718 might cause the processor(s) 904 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 700, various computer-readable media might be involved in providing instructions/code to processor(s) 704 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as the working memory 718. Transmission media include, without limitation, coaxial cables, copper wire and fiber optics, including the wires that comprise the bus 702, as well as the various components of the communications subsystem 712 (and/or the media by which the communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 904 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 712 (and/or components thereof) generally will receive the signals, and the bus 702 then might carry the signals (and/or the data, instructions, etc. carried by the signals) to the working memory 718, from which the processor(s) 704 retrieves and executes the instructions. The instructions received by the working memory 718 may optionally be stored on a non-transitory storage device 706 either before or after execution by the processor(s) 704.

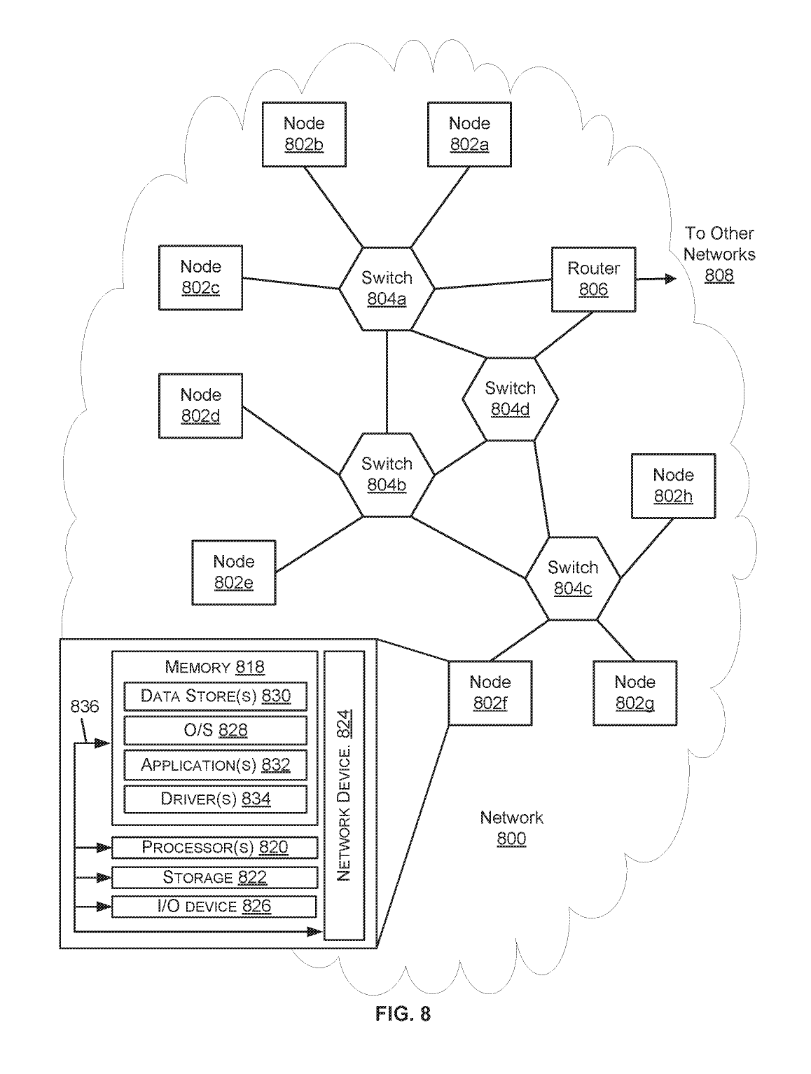

FIG. 8 illustrates a network 800, illustrating various different types of computer devices of FIG. 7, such as nodes comprising the computer device, switches and routers. In certain embodiments, the network 800 may be based on a switched architecture with point-to-point links. Network 800 can be used to implement social network infrastructure 80. As illustrated in FIG. 8, the network 800 can include a plurality of switches 804a-804d, which may be arranged in a network. In some cases, the switches are arranged in a multi-layered network, such as a Clos network. A device that filters and forwards packets between local area network (LAN) segments may be referred to as a switch. Switches generally operate at the data link layer (layer 2) and sometimes the network layer (layer 3) of the Open System Interconnect (OSI) Reference Model and may support several packet protocols. Switches 804a-804d may be connected to a plurality of nodes 802a-802h and provide multiple paths between any two nodes.

The network 800 may also include one or more devices for connection with other networks 808, such as other subnets, LANs, wide area networks (WANs), or the Internet, and may be referred to as routers 806. Routers can use headers and forwarding tables to determine the best path for forwarding the packets, and use protocols such as internet control message protocol (ICMP) to communicate with each other and configure the best route between any two devices.

In some examples, network(s) 800 may include any one or a combination of many different types of networks, such as cable networks, wireless networks, cellular networks and other private and/or public networks. Interconnected switches 804a-804d and router 806, if present, may be referred to as a switch fabric, a fabric, a network fabric, or simply a network. In the context of a computer network, terms “fabric” and “network” may be used interchangeably herein.

Nodes 802a-802h may be any combination of host systems, processor nodes, storage subsystems, and I/O chassis that represent user devices, service provider computers or third party computers.

User devices may include computing devices to access an application 832 (e.g., a web browser or mobile device application). In some aspects, the application 832 may be hosted, managed, and/or provided by a computing resources service or service provider. The application 832 may allow the user(s) to interact with the service provider computer(s) to, for example, access web content (e.g., web pages, music, video, etc.). The user device(s) may be a computing device such as for example a mobile phone, a smart phone, a personal digital assistant (PDA), a laptop computer, a netbook computer, a desktop computer, a thin-client device, a tablet computer, an electronic book (e-book) reader, a gaming console, etc. In some examples, the user device(s) may be in communication with the service provider computer(s) via the other network(s) 808. Additionally, the user device(s) may be part of the distributed system managed by, controlled by, or otherwise part of the service provider computer(s) (e.g., a console device integrated with the service provider computers).

The node(s) of FIG. 8 may also represent one or more service provider computers. One or more service provider computers may provide a native application that is configured to run on the user devices, which user(s) may interact with. The service provider computer(s) may, in some examples, provide computing resources such as, but not limited to, client entities, low latency data storage, durable data storage, data access, management, virtualization, cloud-based software solutions, electronic content performance management, and so on. The service provider computer(s) may also be operable to provide web hosting, databasing, computer application development and/or implementation platforms, combinations of the foregoing or the like to the user(s). In some embodiments, the service provider computer(s) may be provided as one or more virtual machines implemented in a hosted computing environment. The hosted computing environment may include one or more rapidly provisioned and released computing resources. These computing resources may include computing, networking and/or storage devices. A hosted computing environment may also be referred to as a cloud computing environment. The service provider computer(s) may include one or more servers, perhaps arranged in a cluster, as a server farm, or as individual servers not associated with one another and may host the application 832 and/or cloud-based software services. These servers may be configured as part of an integrated, distributed computing environment. In some aspects, the service provider computer(s) may, additionally or alternatively, include computing devices such as for example a mobile phone, a smart phone, a personal digital assistant (PDA), a laptop computer, a desktop computer, a netbook computer, a server computer, a thin-client device, a tablet computer, a gaming console, etc. In some instances, the service provider computer(s), may communicate with one or more third party computers.

In one example configuration, the node(s) 802a-802h may include at least one memory 818 and one or more processing units (or processor(s) 820). The processor(s) 820 may be implemented in hardware, computer-executable instructions, firmware, or combinations thereof. Computer-executable instruction or firmware implementations of the processor(s) 820 may include computer-executable or machine-executable instructions written in any suitable programming language to perform the various functions described.

In some instances, the hardware processor(s) 820 may be a single core processor or a multi-core processor. A multi-core processor may include multiple processing units within the same processor. In some embodiments, the multi-core processors may share certain resources, such as buses and second or third level caches. In some instances, each core in a single or multi-core processor may also include multiple executing logical processors (or executing threads). In such a core (e.g., those with multiple logical processors), several stages of the execution pipeline and also lower level caches may also be shared.

The memory 818 may store program instructions that are loadable and executable on the processor(s) 820, as well as data generated during the execution of these programs. Depending on the configuration and type of the node(s) 802a-802h, the memory 818 may be volatile (such as RAM) and/or non-volatile (such as ROM, flash memory, etc.). The memory 818 may include an operating system 828, one or more data stores 830, one or more application programs 832, one or more drivers 834, and/or services for implementing the features disclosed herein.

The operating system 828 may support nodes 802a-802h basic functions, such as scheduling tasks, executing applications, and/or controller peripheral devices. In some implementations, a service provider computer may host one or more virtual machines. In these implementations, each virtual machine may be configured to execute its own operating system. Examples of operating systems include Unix, Linux, Windows, Mac OS, iOS, Android, and the like. The operating system 828 may also be a proprietary operating system.

The data stores 830 may include permanent or transitory data used and/or operated on by the operating system 828, application programs 832, or drivers 834. Examples of such data include web pages, video data, audio data, images, user data, and so on. The information in the data stores 830 may, in some implementations, be provided over the network(s) 808 to user devices 804. In some cases, the data stores 830 may additionally or alternatively include stored application programs and/or drivers. Alternatively or additionally, the data stores 830 may store standard and/or proprietary software libraries, and/or standard and/or proprietary application user interface (API) libraries. Information stored in the data stores 830 may be machine-readable object code, source code, interpreted code, or intermediate code.

The drivers 834 include programs that may provide communication between components in a node. For example, some drivers 834 may provide communication between the operating system 828 and additional storage 822, network device 824, and/or I/O device 826. Alternatively or additionally, some drivers 834 may provide communication between application programs 832 and the operating system 828, and/or application programs 832 and peripheral devices accessible to the service provider computer. In many cases, the drivers 834 may include drivers that provide well-understood functionality (e.g., printer drivers, display drivers, hard disk drivers, Solid State Device drivers). In other cases, the drivers 834 may provide proprietary or specialized functionality.

The service provider computer(s) or servers may also include additional storage 822, which may include removable storage and/or non-removable storage. The additional storage 822 may include magnetic storage, optical disks, solid state disks, flash memory, and/or tape storage. The additional storage 822 may be housed in the same chassis as the node(s) 802a-802h or may be in an external enclosure. The memory 818 and/or additional storage 822 and their associated computer-readable media may provide non-volatile storage of computer-readable instructions, data structures, program modules, and other data for the computing devices. In some implementations, the memory 818 may include multiple different types of memory, such as SRAM, DRAM, or ROM.

The memory 818 and the additional storage 822, both removable and non-removable, are examples of computer-readable storage media. For example, computer-readable storage media may include volatile or non-volatile, removable or non-removable media implemented in a method or technology for storage of information, the information including, for example, computer-readable instructions, data structures, program modules, or other data. The memory 818 and the additional storage 822 are examples of computer storage media. Additional types of computer storage media that may be present in the node(s) 802a-802h may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, solid state drives, or some other medium which can be used to store the desired information and which can be accessed by the node(s) 802a-802h. Computer-readable media also includes combinations of any of the above media types, including multiple units of one media type.

Alternatively or additionally, computer-readable communication media may include computer-readable instructions, program modules or other data transmitted within a data signal, such as a carrier wave or other transmission. However, as used herein, computer-readable storage media does not include computer-readable communication media.

The node(s) 802a-802h may also include I/O device(s) 826, such as a keyboard, a mouse, a pen, a voice input device, a touch input device, a display, speakers, a printer, and the like. The node(s) 802a-802h may also include one or more communication channels 836. A communication channel 836 may provide a medium over which the various components of the node(s) 802a-802h can communicate. The communication channel or channels 836 may take the form of a bus, a ring, a switching fabric, or a network.

The node(s) 802a-802h may also contain network device(s) 826 that allow the node(s) 802a-802h to communicate with a stored database, another computing device or server, user terminals and/or other devices on the network(s) 800. Each of node(s) 802a-802h of FIG. 8 may include similar components and/or functionality discussed with regarding to computer system 700 of FIG. 7.

In some implementations, the network device 826 is a peripheral device, such as a PCI-based device. In these implementations, the network device 826 includes a PCI interface for communicating with a host device. The term “PCI” or “PCI-based” may be used to describe any protocol in the PCI family of bus protocols, including the original PCI standard, PCI-X, Accelerated Graphics Port (AGP), and PCI-Express (PCIe) or any other improvement or derived protocols that are based on the PCI protocols discussed herein. The PCI-based protocols are standard bus protocols for connecting devices, such as a local peripheral device to a host device. A standard bus protocol is a data transfer protocol for which a specification has been defined and adopted by various manufacturers. Manufacturers ensure that compliant devices are compatible with computing systems implementing the bus protocol, and vice versa. As used herein, PCI-based devices also include devices that communicate using Non-Volatile Memory Express (NVMe). NVMe is a device interface specification for accessing non-volatile storage media attached to a computing system using PCIe. For example, the bus interface module 808 may implement NVMe, and the network device 826 may be connected to a computing system using a PCIe interface.

A PCI-based device may include one or more functions. A “function” describes operations that may be provided by the network device 826. Examples of functions include mass storage controllers, network controllers, display controllers, memory controllers, serial bus controllers, wireless controllers, and encryption and decryption controllers, among others. In some cases, a PCI-based device may include more than one function. For example, a PCI-based device may provide a mass storage controller and a network adapter. As another example, a PCI-based device may provide two storage controllers, to control two different storage resources. In some implementations, a PCI-based device may have up to eight functions.

In some implementations, the network device 826 may include single-root I/O virtualization (SR-IOV). SR-IOV is an extended capability that may be included in a PCI-based device. SR-IOV allows a physical resource (e.g., a single network interface controller) to appear as multiple resources (e.g., sixty-four network interface controllers). Thus, a PCI-based device providing a certain functionality (e.g., a network interface controller) may appear to a device making use of the PCI-based device to be multiple devices providing the same functionality. The functions of an SR-IOV-capable storage adapter device may be classified as physical functions (PFs) or virtual functions (VFs). Physical functions are fully featured functions of the device that can be discovered, managed, and manipulated. Physical functions have configuration resources that can be used to configure or control the storage adapter device. Physical functions include the same configuration address space and memory address space that a non-virtualized device would have. A physical function may have a number of virtual functions associated with it. Virtual functions are similar to physical functions, but are light-weight functions that may generally lack configuration resources, and are generally controlled by the configuration of their underlying physical functions. Each of the physical functions and/or virtual functions may be assigned to a respective thread of execution (such as for example, a virtual machine) running on a host device.

The modules described herein may be software modules, hardware modules or a suitable combination thereof. If the modules are software modules, the modules can be embodied on a non-transitory computer readable medium and processed by a processor in any of the computer systems described herein. It should be noted that the described processes and architectures can be performed either in real-time or in an asynchronous mode prior to any user interaction. The modules may be configured in the manner suggested in FIG. 7, FIG. 8, and/or functions described herein can be provided by one or more modules that exist as separate modules and/or module functions described herein can be spread over multiple modules.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 1204—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A computer system, comprising:
one or more internetworked computer devices, the one or more internetworked computer devices implementing a social network, wherein the one or more internetworked computer devices are configured to:
identify a user action relating to a user on the social network;
obtain values of one or more predetermined features associated with the user action on the social network or the user on the social network;
provide the values of the one or more predetermined features to a classifier implemented on the one or more internetworked computer devices, wherein the classifier is trained using (1) previous values of the one or more predetermined features associated with previous user actions on the social network or users on the social network and (2) known outcomes of prior decisions, based on the previous values, to trigger suicide or self-injury (SSI) risk mitigation activity;
obtain an output from the classifier, the output based on values of the one or more predetermined features associated with the user action or the user; and
based on output from the classifier, in response to the user action, determine to perform one or more responsive actions to mitigate SSI risk to the user.

2. The computer system of claim 1,
wherein the user action is one of a plurality of user actions reported by users of the social network as corresponding to SSI risk; and
wherein the one or more responsive actions includes prioritizing the user action, among the plurality of user actions, for manual review.

3. The computer system of claim 1, wherein the user action is not reported, by a user of the social network, as relating to SSI risk.

4. The computer system of claim 1, wherein the user action comprises:
posting a content item, by the user, to the social network.

5. The computer system of claim 4, wherein the one or more predetermined features include text from the content item.

6. The computer system of claim 4, wherein the one or more predetermined features include a feature based on a response to the posting of the content item, the response being by another user of the social network.

7. The computer system of claim 6, wherein the other user corresponds to a user profile that is associated, prior to the user action, via the social network, to a user profile of the user.

8. The computer system of claim 1,
wherein the classifier comprises a first tier of at least one sub-classifier and a second tier of at least one sub-classifier, and
wherein the second tier of at least one sub-classifier takes, as inputs, outputs from the first tier of at least one sub-classifier.

9. The computer system of claim 8, wherein at least one of the first tier of at least one sub-classifier is a text-based sub-classifier configured to receive textual input.

10. The computer system of claim 9, wherein at least one of the text-based sub-classifiers is configured to receive, as input, an n-gram of text as part of the one or more predetermined features.

11. The computer system of claim 9, wherein each sub-classifier of the first tier of at least one sub-classifier is configured to output a numeric value relevant to the determining to perform one or more responsive actions to mitigate SSI risk to the user.

12. The computer system of claim 11, wherein the at least one sub-classifier configured to output a numeric value is further configured to receive, as input, a value indicative of a time of day that the user action occurred.

13. The computer system of claim 1, wherein the one or more predetermined features include a group within the social network of which the user is a member, one or more associations of the user within the social network, or biographical information entered to the social network by the user.

14. The computer system of claim 1, wherein the one or more actions to mitigate SSI risk to the user include:
(1) generation of a message addressed to a friend of the user, the message indicating that the user may require assistance;
(2) generation of a message to the user including assistive information for mitigating SSI risk to the user;
(3) generation of a message addressed to the user including contact information for a third party to mitigate SSI risk to the user; or
(4) generation of a message addressed to authorities to intervene in response to determining that the user requires assistance.

15. The computer system of claim 1, wherein the one or more predetermined features associated with the user on the social network include features contained within a profile on the social network, the profile corresponding to the user.

16. The computer system of claim 1, wherein the known outcomes of prior decisions, based on the previous user actions, to trigger suicide or self-injury (SSI) risk mitigation activity are determined based on manual selection of the outcomes based on the previous values of the one or more predetermined features associated with the previous user actions on the social network.

17. A method, comprising:
identifying, by one or more internetworked computer devices, a user action relating to a user on a social network, wherein the one or more internetworked computer devices implement the social network;
obtaining, by the one or more internetworked computer devices, values of one or more predetermined features associated with the user action on the social network or the user on the social network;
providing, by the one or more internetworked computer devices, the values of the one or more predetermined features to a classifier implemented on the one or more internetworked computer devices;
wherein the classifier is trained using (1) previous values of the one or more predetermined features associated with previous user actions on the social network or users on the social network and (2) known outcomes of prior decisions, based on the previous values, to trigger suicide or self-injury (SSI) risk mitigation activity;
obtaining, by the one or more internetworked computer devices, an output from the classifier, the output based on values of the one or more predetermined features associated with the user action or user; and
based on output from the classifier, determining, in response to the user action, by the one or more internetworked computer devices, to perform one or more responsive actions to mitigate SSI risk to the user.

18. The method of claim 17, further comprising:
periodically updating the classifier with (1) values of the one or more predetermined features associated with previous user actions on the social network and (2) known outcomes of prior decisions, based on the previous user actions, to trigger suicide or self-injury (SSI) risk mitigation activity.

19. The method of claim 17, further comprising:
manually verifying a determination by the by the one or more internetworked computer devices to perform the one or more responsive actions.

20. One or more non-transitory computer-readable media storing computer-executable instructions that, when executed, cause one or more internetworked computer devices to:
identify a user action by a user on a social network, wherein the one or more internetworked computer devices implement the social network;
obtain values of one or more predetermined features associated with the user action on the social network or the user on the social network;
provide the values of the one or more predetermined features to a classifier implemented on the one or more internetworked computer devices;
wherein the classifier is trained using (1) previous values of the one or more predetermined features associated with previous user actions on the social network or users on the social network and (2) known outcomes of prior decisions, based on the previous values, to trigger suicide or self-injury (SSI) risk mitigation activity;
obtain an output from the classifier, the output based on values of the one or more predetermined features associated with the user action or user; and
based on output from the classifier, in response to the user action, determining to perform one or more responsive actions to mitigate SSI risk to the user.
